(19) United States
(12) Patent Application Publication
(10) Pub. No.: US 2018/0252026 A1
(43) Pub. Date: Sep. 6, 2018

(54) ARCHITECTURAL MESH WITH AIR FLOW FLAPS

(71) Applicant: CAMBRIDGE INTERNATIONAL, INC., Cambridge, MD (US)

(72) Inventors: Frank R. BARCUS, III, Cambridge, MD (US); Robert E. MAINE, JR., Salisbury, MD (US); George H. MESSICK, JR., Cambridge, MD (US); Matthew Charles O'CONNELL, Cambridge, MD (US); Thomas O. PERDUE, Salisbury, MD (US); Hendrik Arie PHILLIPS, Seaford, DE (US); Thomas Claude ROSS, Port Isabel, TX (US); Jeffery D. ULCHAK, Salisbury, MD (US)

(73) Assignee: CAMBRIDGE INTERNATIONAL, INC., Cambridge, MD (US)

(21) Appl. No.: 15/911,862

(22) Filed: Mar. 5, 2018

Related U.S. Application Data
(60) Provisional application No. 62/466,707, filed on Mar. 3, 2017.

(51) Int. Cl. E06B 7/02; E06B 9/52; E06B 7/28

(52) U.S. Cl. CPC E06B 7/02; E06B 2007/023; E06B 7/28; E06B 9/52

(57) ABSTRACT

An architectural panel includes a mesh defining a plurality of openings and a plurality of flaps configured for attachment to the mesh within the plurality of openings, the flaps being movable to allow air flow through the openings.

### TECHNICAL FIELD

The disclosure herein is directed to an architectural panel and, more particularly, to an architectural metal mesh panel assembled from a wire mesh and movable air flow flaps to provide the overall desired shading or privacy characteristics without a high wind loading.

### BACKGROUND

Architectural meshes are generally used in commercial and business environments to provide elegant wall panels, doors and other surfaces whenever an aesthetic appearance of polish and prestige are of primary importance. Architectural mesh is also an excellent choice for high contact areas, such as the interior walls of elevator cabs, escalator walls, and sales and reception areas, because it is generally scratch, dent and corrosion resistant. As such, architectural mesh maintains a stunning appearance with minimal maintenance.

Woven into panels from brass, stainless steel, copper, and/or other desired metals or alloys, architectural mesh offers a richness of texture, pattern and color that cannot be duplicated by any other material. Architectural mesh can also be polished, finished and combined with different background colors to create a custom look and configuration. Depending upon the chosen weave, the interstices or apertures between the weft or fill wires and the warp wires may allow light to pass through the architectural mesh. Alternatively, if the weave is tight and the wires are more closely adjacent to one another, the passage of light through the mesh will be selectively prevented. However, in such a tightly woven mesh, the wind loading is also increased.

Accordingly, as the requirement for incorporating energy savings into building design increases, and hence the need for architecturally acceptable sun shading or privacy screening increases, it would be desirable to have available options for varying the aesthetic appearance of an architectural mesh product, and particularly with respect to its application as a sun or privacy screen, to vary the aesthetic appearance without a high wind loading.

### SUMMARY

The disclosure herein addresses the above concerns by providing an architectural panel comprising a mesh defining a plurality of openings and a plurality of flaps configured for attachment to the mesh within the plurality of openings, the flaps being movable to allow air flow through the openings. According to an exemplary embodiment, the flaps are connected to the mesh by a plurality of clips.

According to a further aspect of the disclosure, the mesh comprises a flat wire mesh including a plurality of U-shaped links and a plurality of connecting rods and the flaps are connected to the mesh by a plurality of clips, the clips being configured to engage the plurality of connecting rods.

### BRIEF DESCRIPTION OF THE DRAWING FIGURES

These and other objects, features, and advantages of the present invention will become more readily apparent to those skilled in the art upon reading the following detailed description, in conjunction with the appended drawings in which:

FIG. 1 is a perspective view of an exemplary embodiment of an architectural mesh according to the disclosure herein.

FIG. 2 is a front elevational view of the architectural mesh shown in FIG. 1.

FIG. 3 is a side elevational view of the architectural mesh shown in FIG. 2.

FIG. 4 is an enlarged perspective view of a flap on the architectural mesh according to an exemplary embodiment of the disclosure.

FIG. 5 is a side elevational view of the flap shown in FIG. 4.

FIG. 6 is an enlarged perspective view of a flap on the architectural mesh according to a further exemplary embodiment of the disclosure.

FIG. 7 is an enlarged perspective view of a flap on the architectural mesh according to another exemplary embodiment of the disclosure.

FIG. 8 is a perspective view of a further exemplary embodiment of an architectural mesh according to the disclosure herein.

FIG. 9 is a perspective view of another embodiment of an architectural mesh according to the disclosure herein.

FIG. 10 is a perspective view of yet another exemplary embodiment of an architectural mesh according to the disclosure herein.

### DETAILED DESCRIPTION

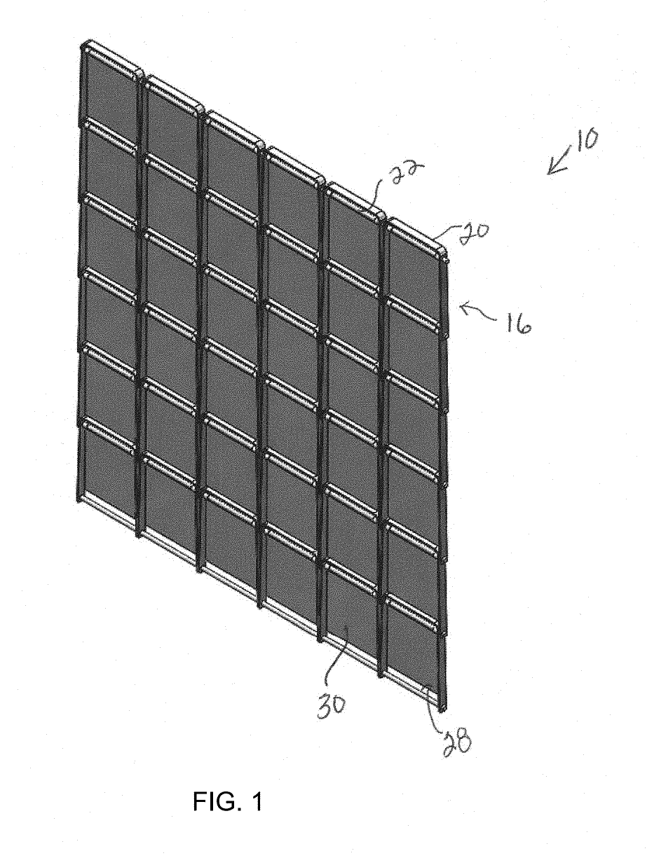

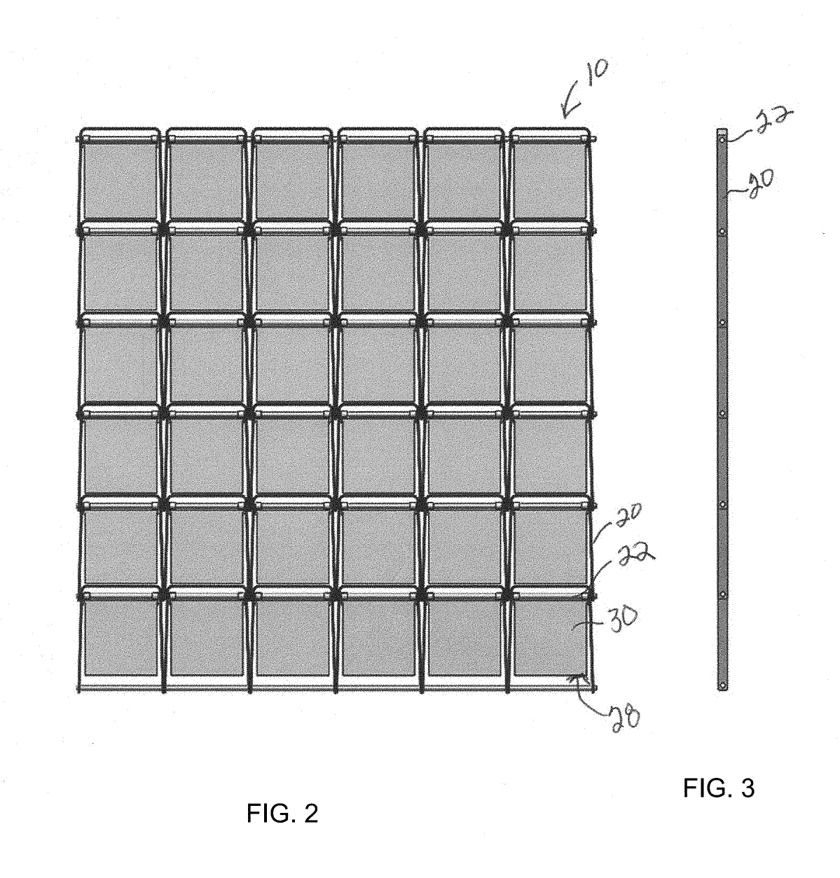

A portion of an architectural mesh panel in accordance with an exemplary embodiment of the disclosure herein is shown generally in FIGS. 1-3 by reference numeral 10. The illustrated architectural mesh panel 10 is preferably a flat wire style mesh. In assembling the architectural mesh, a plurality of U-shaped links, such as 20 in FIG. 1, is associated with two connector rods 22 positioned to be sequentially adjacent in the vertical (or horizontal) direction of the architectural mesh panel 10 and to thereby define a row 16. The combination of the plurality of U-shaped links 20 and two associated connector rods 22 defines a plurality of widthwise side-by-side open recesses or openings 28. Flaps 30 are installed in the recesses 28 in order to provide increased shading and/or privacy as desired. More particularly, the flaps 30 can be placed in every recess 28 of the mesh or they can be placed in a predetermined pattern to obtain a desired aesthetic or function.

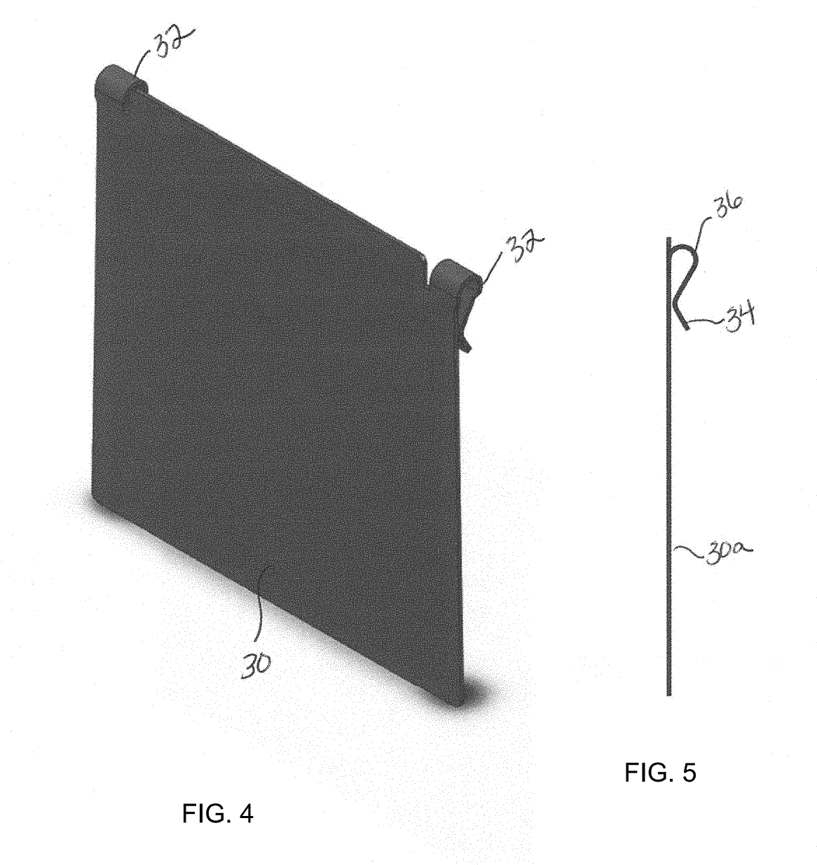

Referring also to FIGS. 4 and 5, an exemplary embodiment of flap 30 is shown as a solid surface. Flaps 30 include a plurality of clips 32 for the removable attachment of the flaps to the mesh 10, and preferably two clips 32, one being disposed on each top edge of the flap. Each clip 32 comprises a rounded head area 36 and a bent tine 34 so as to resemble a cotter pin and enables engagement with the connector rods 22 of the mesh. That is, the flaps 30 clip onto the connector rods 22 by applying a force sufficient to move the bent time 34 away from the rear surface 30a of the flap a sufficient distance “x” such that the connector rod 22 can pass therebetween and be retained within the head area 36 of the clip 32. The flaps 30 are thus removably secured to the underlying rows 16 of U-shaped elements but, since the flaps 30 are also free to sway in the wind, the flaps thus reduce the wind load on the architectural mesh as compared to a tightly woven mesh. Preferably, the flap movement ranges from approximately 136 degrees in a rearward direction (towards the clip 32) and approximately 118 degrees in a forward direction without becoming disengaged or wedged with the connector rods, although other degrees of movement are of course also possible. The flaps are configured to clip into the mesh for easy installation and customization of the architectural product.

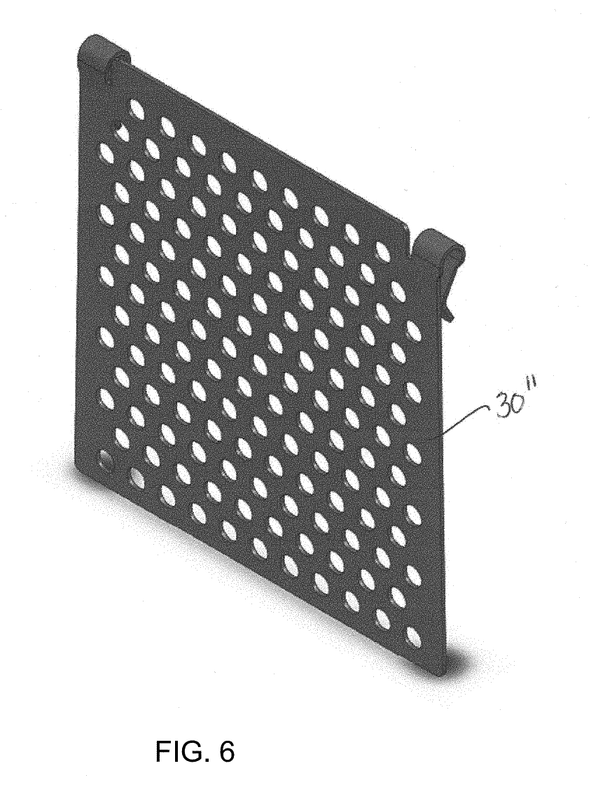

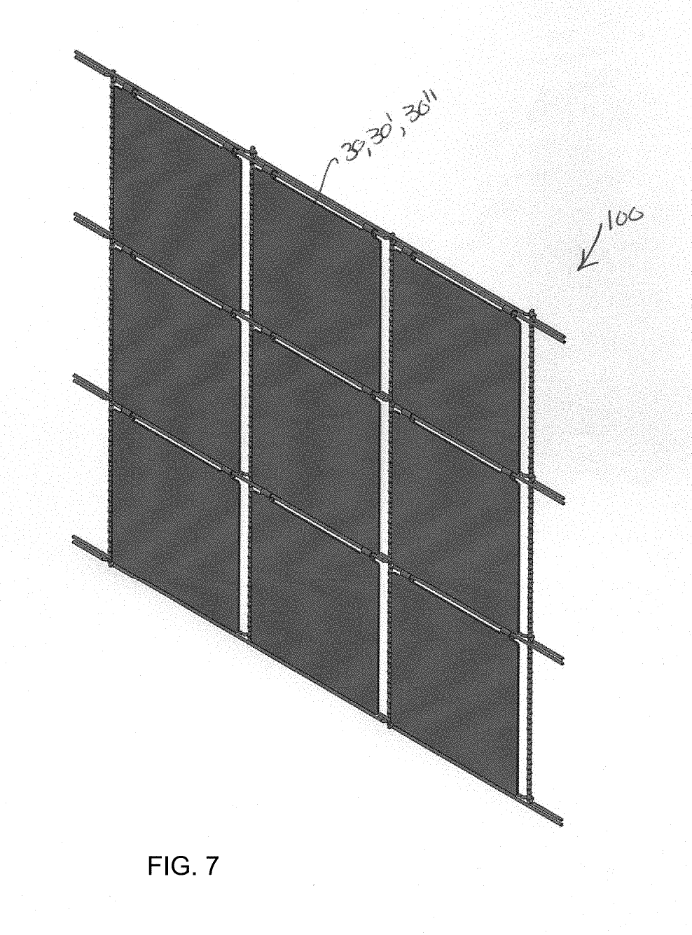

According to further exemplary embodiments of the disclosure, the flaps can be made from a woven material as shown by flap 30′ in FIG. 6 or a perforated material as shown by flap 30″ in FIG. 7.

In addition, the flaps can be made from a variety of materials such as metals and plastics, finishes, colors, and shapes as needed to achieve the desired aesthetic or functional purpose. The flaps can also be made with different patterns and installed to create large scale images on an architectural mesh panel. The flaps could also include a cut-out portion defining a predetermined pattern, or an embossed graphic or text.

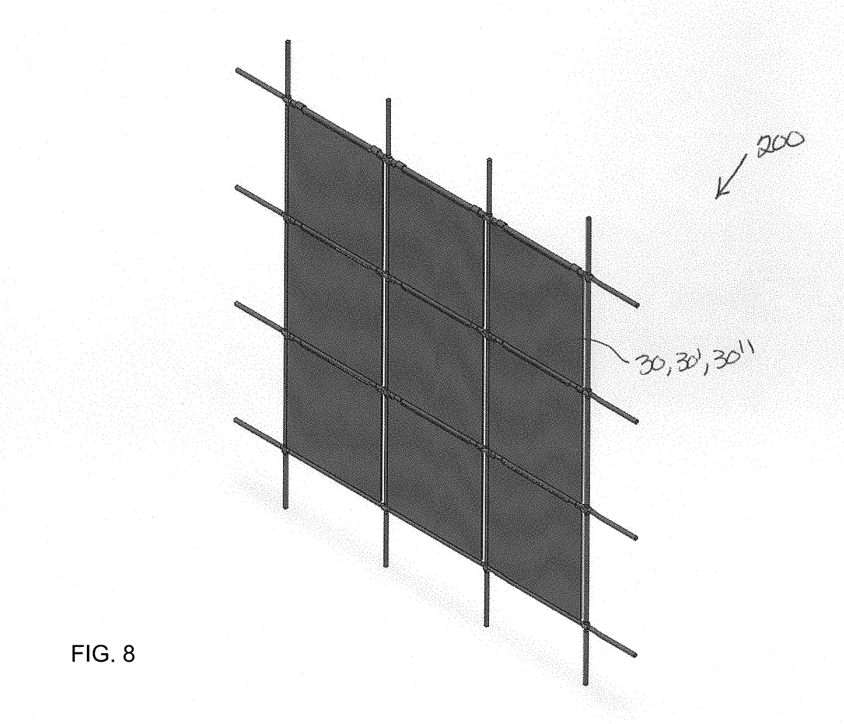

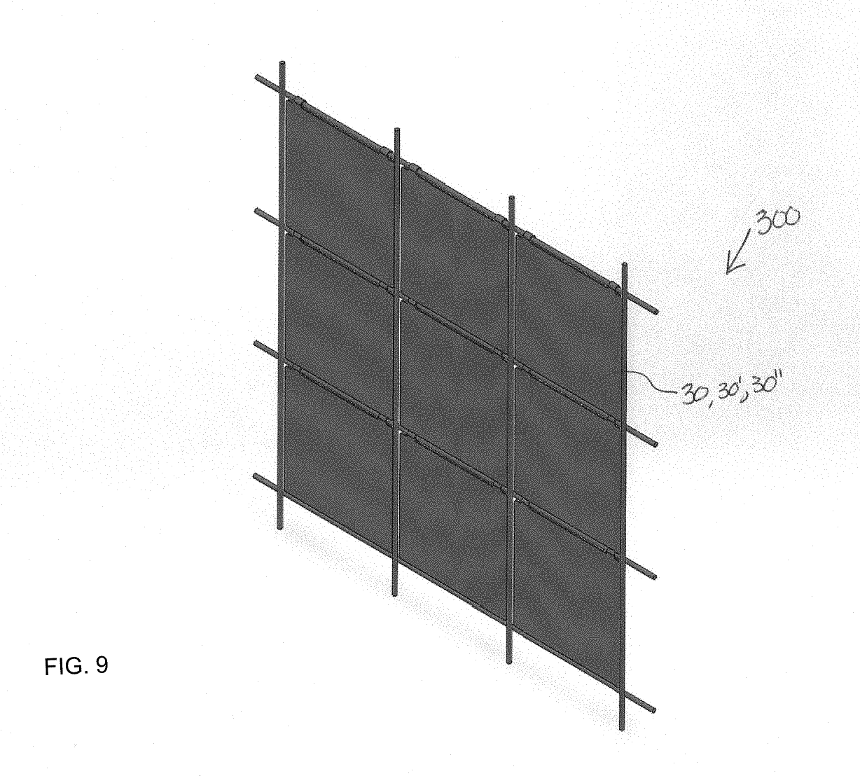

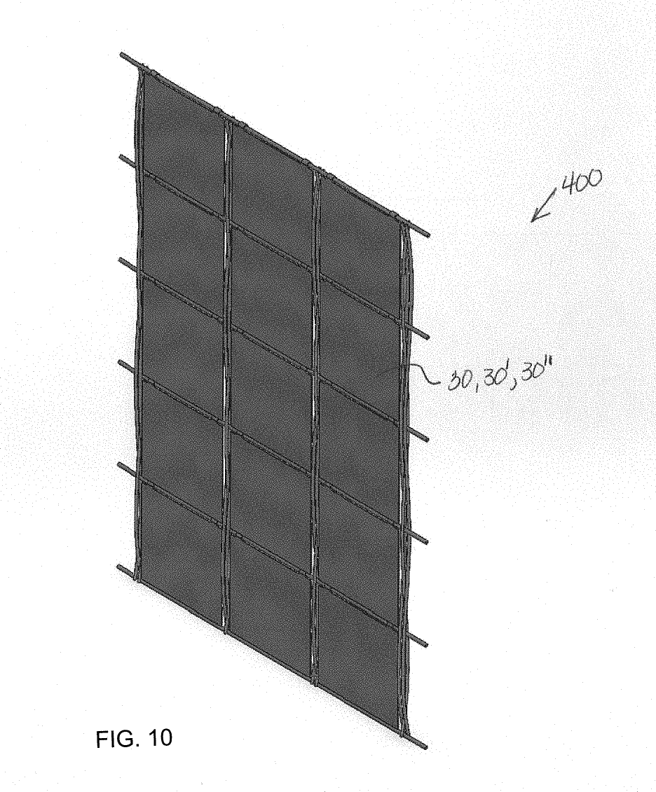

The flaps can be utilized on any type of architectural mesh product having a plurality of open area recesses. Hence in addition to the flat wire style mesh described and shown above, the flaps 30, 30′, 30″ can be used on a mesh 100 formed by an exemplary embodiment of a cable rod mesh as shown in FIG. 8, a woven wire mesh 200 as shown in FIG. 9, a welded wire mesh 300 as shown in FIG. 10, a braided cable rod wire mesh 400 as shown in FIG. 11, or any other type of known mesh product defining a plurality of open area recesses.

While the disclosure here has been described with respect to a particular exemplary embodiments, this is by way of illustration for purposes of disclosure rather than to confine the invention to any specific arrangement as there are various alterations, changes, deviations, eliminations, substitutions, omissions and departures which may be made in the particular embodiment shown and described without departing from the scope of the claims.

We claim:

1. An architectural panel comprising:
a mesh defining a plurality of openings; and
a plurality of flaps configured for attachment to the mesh within the plurality of openings, said flaps being movable to allow air flow through the openings.

2. The architectural panel according to claim 1, wherein said plurality of flaps are connected to said mesh at a rear side of said flaps.

3. The architectural panel according to claim 1, wherein said flaps are connected to said mesh by a plurality of clips.

4. The architectural panel according to claim 1, wherein said flaps and said mesh are formed from a same material.

5. The architectural panel according to claim 1, wherein said flaps and said mesh are formed from a different material.

6. The architectural panel according to claim 1, wherein said mesh comprises a flat wire mesh comprising a plurality of U-shaped links and a plurality of connecting rods.

7. The architectural panel according to claim 6, wherein said flaps are connected to said mesh by a plurality of clips, said clips being configured to engage the plurality of connecting rods.

8. The architectural panel according to claim 1, wherein said mesh comprises a woven wire mesh.

9. The architectural panel according to claim 1, wherein said mesh comprises a welded wire mesh.

10. The architectural panel according to claim 1, wherein said mesh comprises a cable rod mesh.

11. The architectural panel according to claim 1, wherein said mesh comprises a woven wire mesh.

12. The architectural panel according to claim 1, wherein a plurality of flaps define a solid surface.

13. The architectural panel according to claim 1, wherein a plurality of flaps define a perforated surface.

14. The architectural panel according to claim 1, wherein a plurality of flaps are formed by a woven material.

15. The architectural panel according to claim 1, wherein the plurality of flaps are disposed in a predetermined number of said plurality of openings.

16. The architectural panel according to claim 1, wherein the plurality of flaps are disposed in all of said plurality of openings.

17. The architectural panel according to claim 1, wherein the plurality of flaps are movable in a forward and reverse direction.

18. The architectural panel according to claim 1, wherein the plurality of flaps are removably attached to the mesh.
